(19) United States
(12) Patent Application Publication
(10) Pub. No.: US 2004/0201272 A1
(43) Pub. Date: Oct. 14, 2004

(54) ABS yaw control with yaw rate sensor

(75) Inventor: Kevin A. O'Dea, Ann Arbor, MI (US)

Correspondence Address: SCOTT A. MCBAIN, DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/408,875

(22) Filed: Apr. 8, 2003

(51) Int. Cl. B60T 8/60

(52) U.S. Cl. 303/146

(57) ABSTRACT

A system and method of controlling a brake system of a vehicle comprising determining a coefficient condition; determining vehicle yaw; determining a driver's corrective action; and determining a brake pressure control response based on the coefficient condition, vehicle yaw and the driver's corrective action.

### TECHNICAL FIELD

This invention relates generally to the field of control of vehicle braking systems, and in particular to a method of vehicle brake control on a split coefficient surface.

### BACKGROUND OF THE INVENTION

A split coefficient road surface is one where the coefficient of friction on one side of the vehicle is significantly different than that on the other side. A road with ice or snow partially covering its surface is an example of a split coefficient road surface. A driver braking a vehicle on such a surface will typically have wheels in contact with a high coefficient (clear) surface and have other wheels in contact with a low coefficient (icy) surface. When the coefficient condition, high or low, is the same for both wheels on one side of the vehicle, a yaw moment is generated. The vehicle will typically yaw away from the low coefficient side when a split coefficient road surface is encountered. The low coefficient side is that side of the vehicle where the wheels are in contact with the low coefficient road surface. ABS braking systems are designed to deal with a split coefficient road surface by regulating the brake pressure at the high coefficient wheels giving the driver time to react and correct the yaw of the vehicle. By lowering brake pressure at that high coefficient side, the driver has an opportunity to react and vehicle stability is increased but consequently stopping distance is also increased. If the driver fails to correct, the vehicle may still become unstable. Current vehicle brake systems do not take advantage of the driver's corrective action. If brake pressure is increased when a driver is correcting, stopping distance is decreased without sacrificing vehicle stability. Accordingly, it would be desirable to have a method of vehicle brake control that overcomes the disadvantages described.

### SUMMARY OF THE INVENTION

One aspect of the invention provides a method of controlling a brake system of a vehicle comprising determining a coefficient condition; determining vehicle yaw; determining a driver's corrective action; and determining a brake pressure control response based on the coefficient condition, vehicle yaw and the driver's corrective action.

Another aspect of the invention provides a system for controlling a brake system of a vehicle comprising means for determining a coefficient condition; means for determining vehicle yaw; means for determining a driver's corrective action; and means for determining a brake pressure control response based on the coefficient condition; vehicle yaw and the driver's corrective action.

Another aspect of the invention provides a computer readable medium storing a computer program for controlling the brake system of a vehicle comprising computer readable code for determining a coefficient condition; computer readable code for determining vehicle yaw; computer readable code for determining a driver's corrective action; and computer readable code for determining a brake pressure control response based on the coefficient condition, vehicle yaw and the driver's corrective action.

### BRIEF DESCRIPTION OF THE DRAWINGS

FIG. 1 is a schematic of one embodiment of a system for vehicle brake pressure control made in accordance with the invention.

FIG. 2 is a flow chart of one embodiment of a method of vehicle brake pressure control made in accordance with the invention.

FIG. 3 is a flow chart detailing a method of vehicle brake pressure control at block 240 of FIG. 2.

FIG. 4 is a flow chart detailing the maximum allowed brake pressure determination at block 310 of FIG. 3.

FIG. 5 is a flow chart detailing the maximum allowed brake pressure modification at block 330 of FIG. 3.

FIG. 6 is a flow chart detailing the current brake pressure adjustment at block 370 of FIG. 3.

### DESCRIPTION OF THE PREFERRED EMBODIMENT

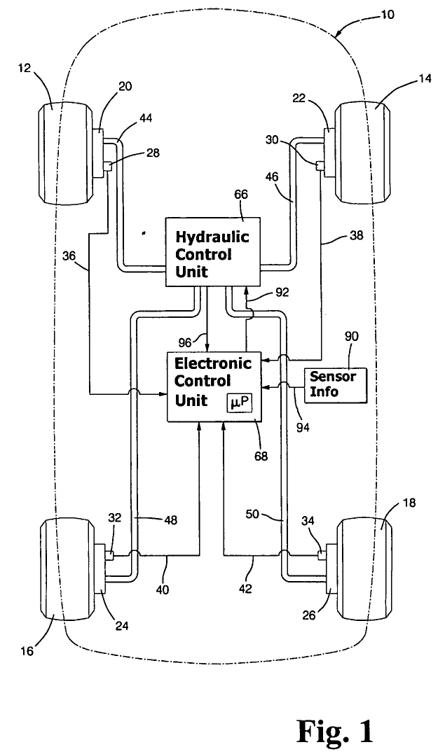

FIG. 1 is a schematic of a system for vehicle brake pressure control. Vehicle 10 has wheels 12, 14, 16, and 18 with respective wheel speed sensors 28, 30, 32, and 34. The wheel speed sensors 28, 30, 32, and 34 send respective wheel speed signals 36, 38, 40, and 42 to electronic control unit 68. The electronic control unit 68 may be a computer, microcomputer, or microprocessor, with ROM and RAM and appropriate input and output circuits.

Besides the wheel speed signals 36, 38, 40, and 42, the electronic control unit 68 also receives yaw rate signals, steering angle signals, master cylinder pressure signals, and other sensor signals 94 from sensor information 90. Other sensor signals including lateral acceleration, and brake pedal position, may be used to establish vehicle status at the electronic control unit 68 as required by the vehicle brake system. The electronic control unit 68 may also receive HCU feedback signal 96 from hydraulic control unit 66.

The electronic control unit 68 is responsive to and processes the wheel speed signals 36, 38, 40, and 42, the yaw rate signals 95 the steering angle signals 96 the master cylinder pressure signals 97 and other sensor signals 94, and the HCU feedback signal 96. The electronic control unit 68 determines the proper vehicle brake control to optimize vehicle braking and sends control signal 92 to the hydraulic control unit 66. The hydraulic control unit 66 uses the control signal 92 to determine brake pressure signals 44, 46, 48, and 50, which control pressure to respective wheel brake systems 20, 22, 24, and 26 for the respective wheels 12, 14, 16, and 18. The hydraulic control unit 66 typically comprises pressure control pumps and solenoid operated actuating valves to rapidly change the brake pressure signals 44, 46, 48, and 50.

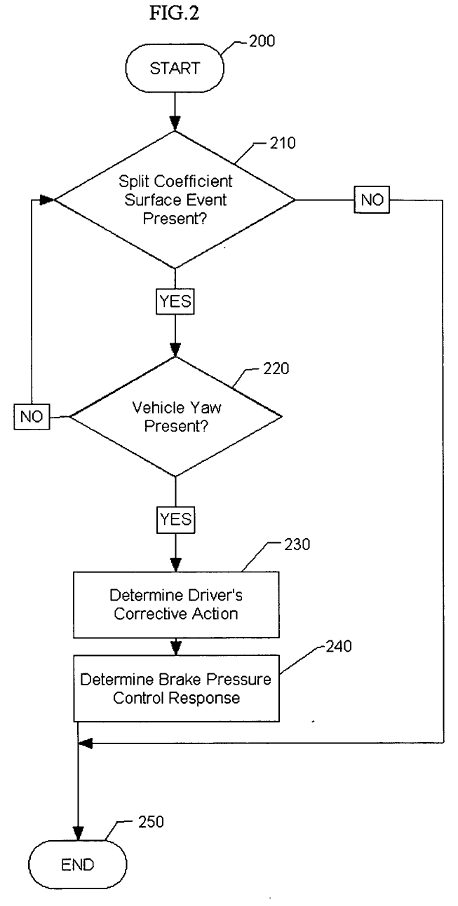

FIG. 2 is a flow chart of a method of brake pressure control. Programmed circuits, such as microcomputers, microprocessors, etc., or discrete components, can be used to carry out the method. The method is active for the duration of a split coefficient surface condition event while anti-lock braking is active as determined by the electronic control unit. After the ‘START’ 200 of the program section described, it is determined whether a coefficient condition is present 210. If not, the program section ends 250. If the coefficient condition is present, it is determined whether vehicle yaw is present 220. If not, the program section ends. If both, a coefficient condition and vehicle yaw, are present, the driver's corrective action is determined 230. The driver's corrective action is driver not correcting if the absolute value of the steering angle is less than predetermined constant k2. The brake pressure control response is determined based on the driver's corrective action, the vehicle yaw, and the coefficient condition 240. If the driver corrects to counter the vehicle yaw, brake pressure is allowed to increase at the wheel brake systems of the high coefficient condition wheels and thus stop the vehicle more quickly but under driver control. If the driver does not correct or stops correcting, brake pressure will be controlled to reduce yaw while braking the vehicle as effectively as possible in a straight line.

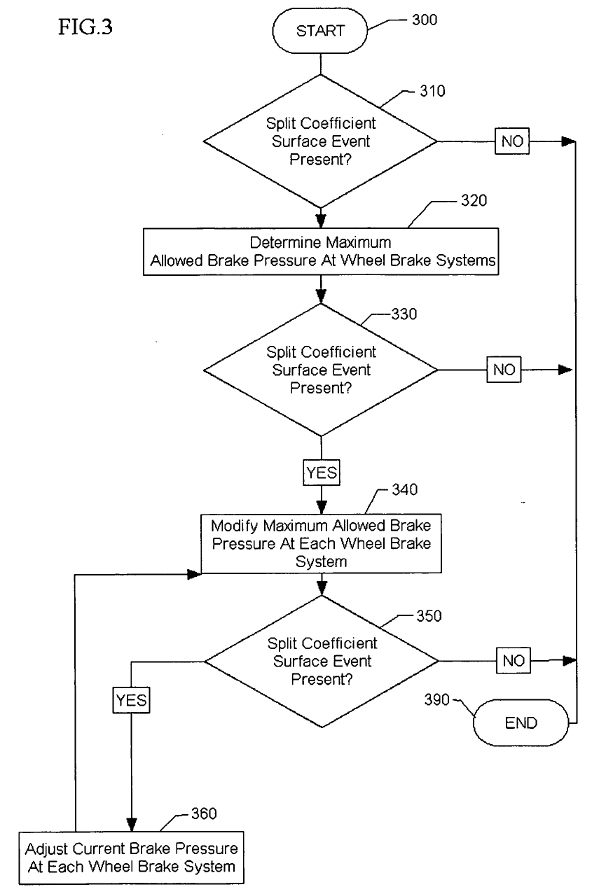

FIG. 3 is a flow chart detailing a preferred embodiment of a method of vehicle brake pressure control at block 240 of FIG. 2. After the ‘START’ 300 of the program section described, if a split coefficient surface condition event is not present 310 the program ends. A maximum allowed brake pressure at each wheel brake system is determined 320 if the split coefficient surface condition event is present 310. If the split coefficient surface event is not present 330, after the brake pressure determination, the program ends 390. If the split coefficient surface event is still present, after the brake pressure determination 330, the maximum allowed brake pressure at each wheel brake system is modified 340. If the split coefficient surface event is no longer present, after the brake pressure modification 350, the program ends 390. If the split coefficient surface event is still present, after the brake pressure modification, the current brake pressure at each wheel brake system is adjusted 360. The maximum allowed brake pressure modification 340 and the current brake pressure adjustment 360 repeat until the split coefficient surface event is no longer present 350 and the program ends 390.

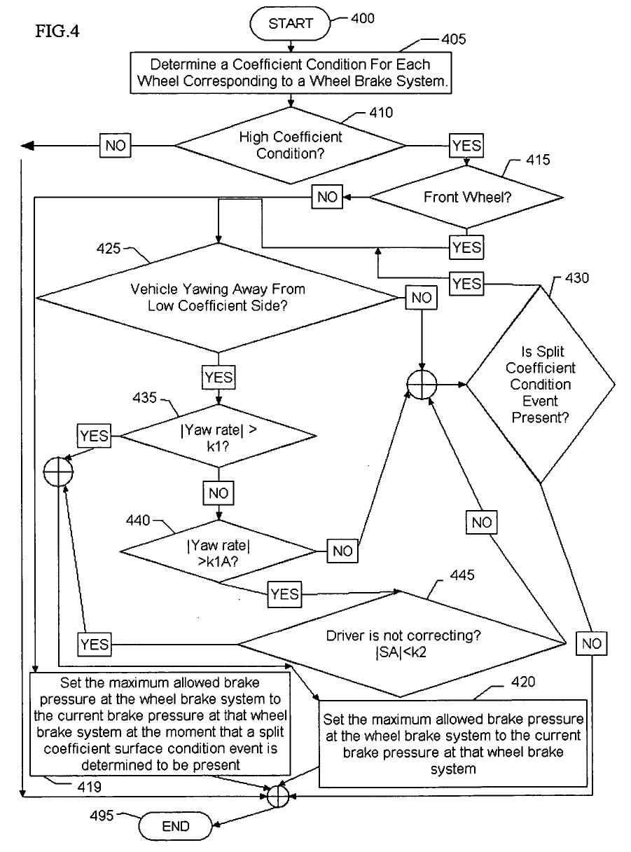

FIG. 4 is a flow chart detailing the maximum allowed brake pressure determination at block 320 of FIG. 3. After the ‘START’ 400 of the program section described, a coefficient condition is determined for each wheel corresponding to a wheel brake system 405. The coefficient condition is either a high coefficient condition or a low coefficient condition and the wheel brake system is for either a front wheel or for a rear wheel. If both wheels on the same side of the vehicle exhibit a low coefficient condition that side of the vehicle is referred to as the low coefficient side. If the coefficient condition is not a high coefficient condition 410 the program section ends 495. If the coefficient condition is a high coefficient condition 410 and the wheel brake system is not for a front wheel 415, the maximum allowed brake pressure at that wheel brake system is set to the current brake pressure at that wheel brake system at the moment that a split condition is determined to be present 419.

The maximum allowed brake pressure is not set if the vehicle is not yawing away from the low coefficient side. If the wheel brake system is for a front wheel 415 and the vehicle is not yawing away from the low coefficient side 425, and the split coefficient surface event is still present 430 the program repeats until the vehicle is yawing away from the low coefficient side. When the vehicle begins to yaw away from the low coefficient side the yaw rate is compared to predetermined constant k1. Where the absolute value of the yaw rate is greater than predetermined constant k1 435, the maximum allowed brake pressure at that wheel brake system is set to the current brake pressure at that wheel brake system 420. Where the absolute value of the yaw rate is not greater than predetermined constant k1 but is greater than predetermined constant k1A 440 and the driver is not correcting 445 the maximum allowed brake pressure at that wheel brake system is set to the current brake pressure at that wheel brake system 420. If the absolute value of the yaw rate is not greater than k1A or the driver corrects, the maximum allowed brake pressure is not set until the yaw rate exceeds k1A or the driver stops correcting. If at any time the split coefficient surface event is not longer present the program section ends 495. This logic allows the brake pressure at the front wheel brake systems to increase as long as the driver is correcting and the yaw rate is not excessive. Stopping distance is minimized if the driver successfully counters the vehicle yaw.

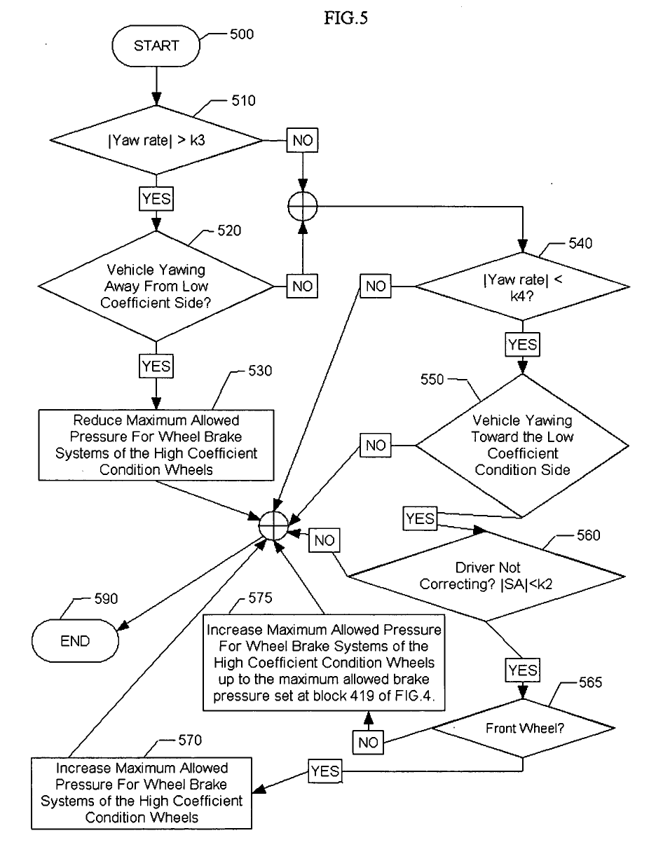

FIG. 5 is a flow chart detailing the maximum allowed brake pressure modification at block 340 of FIG. 3. After the ‘START’ 500 of the program section described, the absolute value of the yaw rate is compared to a predetermined constant k3. If the absolute value of the yaw rate is greater than k3 510 and the vehicle is yawing away from the low coefficient side 520 the maximum allowed pressure at the wheel brake system is reduced by a predetermined increment at the wheel brake systems of the high coefficient condition wheels 530 and the program section ends 590. If the yaw rate is not greater than k3 or the vehicle is not yawing away from the low coefficient side, the yaw rate is compared to a predetermined constant k4. Where the absolute value of the yaw rate is less than k4 540 and the vehicle is yawing toward the low coefficient side 550 and the driver is correcting 560 and the wheel is a front wheel, the maximum allowed brake pressure at the wheel brake systems of the high coefficient condition wheels is increased by a predetermined increment 570. If the wheel is a rear wheel, the maximum allowed pressure at the wheel brake systems is increased, but is not allowed to increase above the value initially set when it was determined that a split condition was present 575. If the absolute value of the yaw rate is not less than k4 or the vehicle is not yawing toward the low coefficient side or the driver is correcting the program section ends 590. The maximum allowed brake pressure is reduced to maintain stability where the driver fails to correct vehicle yaw or stops correcting vehicle yaw and is increased to decrease stopping distance where the driver successfully corrects vehicle yaw.

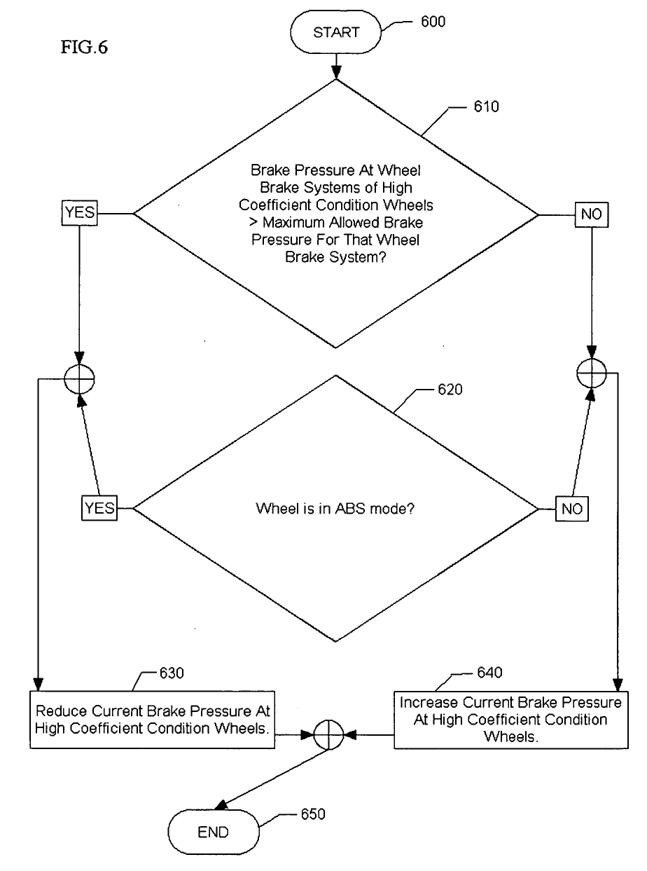

If the split coefficient surface event is still present the vehicle brake system will adjust the current brake pressure at the wheel brake systems of the high coefficient condition wheels as required. FIG. 6 is a flow chart detailing the current brake pressure adjustment at block 360 of FIG. 3. After the ‘START’ 660 of the program section, if the current pressure at the wheel brake systems of the high coefficient condition wheels is greater than the maximum allowed brake pressure at that wheel brake system 610 or the wheel brake system is in ABS mode 620 the current pressure is reduced at the wheel brake systems of the high coefficient condition wheels 630. If the current pressure is not greater than the maximum allowed brake pressure at that wheel brake system 610 or the wheel brake system is not in ABS mode 620 the current pressure is increased at the wheel brake systems of the high coefficient condition wheels 640. In either case the program section ends 650.

The predetermined constants k1, k1A, k2, k3, and k4 are based on vehicle parameters and will vary from vehicle to vehicle. The constants are calibrated and determined empirically for each vehicle.

Although the steps of the program sections above are presented in the preferred order, the steps may be completed in different orders.

The construction and use of the invention and parts thereof previously described and shown in the accompanying drawings is believed to be understandable to those of ordinary skill in the art based on the description and drawings. While the embodiment of the invention disclosed herein is presently considered to be preferred, those skilled in the art will further appreciate that various changes and modifications can be made without departing from the spirit and scope of the invention. The scope of the invention is indicated in the appended claims, and all changes that come within the meaning and range of equivalents are intended to be embraced therein.

1. A method of controlling a brake system of a vehicle, the method comprising:
determining a coefficient condition;
determining vehicle yaw;
determining a driver's corrective action;
determining a brake pressure control response based on the coefficient condition, vehicle yaw, and the driver's corrective action.

2. The method of claim 1 wherein determining the driver's corrective action comprises comparing a steering angle to a predetermined constant.

3. The method of claim 1 wherein determining the vehicle yaw comprises comparing a yaw rate input to a predetermined constant.

4. The method of claim 1 wherein determining the coefficient condition comprises determining if a high coefficient condition or a low coefficient condition is present.

5. The method of claim 1 further comprising:
determining a split coefficient surface event; and determining the coefficient condition responsive to the split coefficient surface event determination.

6. The method of claim 5 wherein determining a brake pressure response comprises determining a plurality of pressure control signals to be sent to wheel brake systems over a duration of the split coefficient surface event.

7. The method of claim 6 wherein determining a brake pressure control response comprises:
determining the wheel brake system corresponding to the coefficient condition;
measuring a current brake pressure based on the corresponding brake system determination; and
setting a maximum allowed brake pressure for the wheel brake system based on the corresponding brake system determination, the vehicle yaw and the driver's corrective action.

8. (cancelled)

9. The method of claim 6 wherein determining a brake pressure control response comprises:
modifying the maximum allowed brake pressure for the wheel brake system based on the vehicle yaw and the driver's corrective action;
comparing the current brake pressure for the wheel brake system to the maximum allowed brake pressure for the wheel brake system; and
adjusting the current brake pressure for the wheel brake system responsive to the brake pressure comparison.

10. The method of claim 6 wherein determining a brake pressure control response comprises:
modifying the maximum allowed brake pressure for the wheel brake system based on the vehicle yaw and the driver's corrective action;
determining if a wheel brake system is in ABS mode; and
adjusting the current brake pressure for the wheel brake system responsive to the ABS mode determination.

11. A computer readable medium storing a computer program for controlling the brake system of a vehicle comprising computer readable code for determining a coefficient condition; computer readable code for determining vehicle yaw; computer readable code for determining a driver's corrective action; and computer readable code for determining a brake pressure control response based on the coefficient condition, vehicle yaw and the driver's corrective action.

12. The computer readable medium of claim 11 wherein the computer readable code for determining the driver's corrective action comprises computer readable code for comparing a steering angle to a predetermined constant.

13. The computer readable medium of claim 11 wherein the computer readable medium for determining the vehicle yaw comprises computer readable code for comparing a yaw rate input to a predetermined constant.

14. The computer readable medium of claim 11 wherein the computer readable code for determining the coefficient condition comprises computer readable code for determining if a high coefficient condition or a low coefficient condition is present.

15. The computer readable medium of claim 11 further comprising: computer readable code for determining a split coefficient surface event; and computer readable code for determining the coefficient condition responsive to the event determination.

16. The computer readable medium of claim 15 wherein the computer readable code for determining a brake pressure response comprises computer readable code for determining a plurality of pressure control signals to be sent to wheel brake systems over a duration of the split coefficient surface event.

17. The computer readable medium of claim 16 wherein the computer readable code for determining a brake pressure control response comprises:
computer readable code for determining the wheel brake system corresponding to the coefficient condition;
computer readable code for measuring a current brake pressure based on the corresponding brake system determination; and
computer readable code for setting a maximum allowed brake pressure for the wheel brake system based on the corresponding brake system determination, the vehicle yaw and the driver's corrective action.

18. (cancelled)

19. The computer readable medium of claim 16 wherein the computer readable code for determining a brake pressure control response comprises:
computer readable code for modifying the maximum allowed brake pressure for the wheel brake system based on the vehicle yaw and the driver's corrective action;
computer readable code for comparing the current brake pressure for the wheel brake system to the maximum allowed brake pressure for the wheel brake system; and
computer readable code for adjusting the current brake pressure for the wheel brake system responsive to the brake pressure comparison.

20. The computer readable medium of claim 16 wherein the computer readable code for determining a brake pressure control response comprises:
computer readable code for modifying the maximum allowed brake pressure for the wheel brake system based on the vehicle yaw and the driver's corrective action;
computer readable code for determining if a wheel brake system is in ABS mode; and
computer readable code for adjusting the current brake pressure for the wheel brake system responsive to the ABS mode determination.

21. A system for controlling a brake system of a vehicle comprising:
means for determining a coefficient condition;
means for determining vehicle yaw;
means for determining a driver's corrective action; and
means for determining a brake pressure control response based on the coefficient condition; vehicle yaw and the driver's corrective action.

22. A method of controlling a brake system of a vehicle, wherein the vehicle comprises a plurality of wheel brake systems, the method comprising:
determining a coefficient condition at each wheel brake system;
determining vehicle yaw;
determining a driver's corrective action;
determining a brake pressure control response at each of the plurality of wheel brake systems based on the coefficient condition and vehicle yaw responsive to the driver's corrective action.

23. A computer readable medium storing a computer program for controlling the brake system of a vehicle, wherein the vehicle comprises a plurality of wheel brake systems, the computer readable medium comprising:
computer readable code for determining a coefficient condition at each wheel brake system;
computer readable code for determining vehicle yaw;
computer readable code for determining a driver's corrective action; and
computer readable code for determining a brake pressure control response at each of the plurality of wheel brake systems based on the coefficient condition and vehicle yaw responsive to the driver's corrective action.

24. A system for controlling a brake system of a vehicle, wherein the vehicle comprises a plurality of wheel brake systems, the system comprising:
means for determining a coefficient condition at each wheel brake system;
means for determining vehicle yaw;
means for determining a driver's corrective action; and
means for determining a brake pressure control response at each of the plurality of wheel brake systems based on the coefficient condition and vehicle yaw responsive to the driver's corrective action.

25. The method of claim 1 wherein the driver's corrective action is selected from the group consisting of “driver is correcting” and “driver not correcting”.
